(19) United States
(12) Patent Application Publication
(10) Pub. No.: US 2014/0247359 A1
(43) Pub. Date: Sep. 4, 2014

(54) SCANNER APPARATUS

(71) Applicant: TOSHIBA TEC KABUSHIKI KAISHA, Tokyo (JP)

(72) Inventor: Shinsuke Yajima, Shizuoka-ken (JP)

(73) Assignee: TOSHIBA TEC KABUSHIKI KAISHA, Tokyo (JP)

(21) Appl. No.: 14/180,468

(22) Filed: Feb. 14, 2014

(30) Foreign Application Priority Data
Mar. 4, 2013 (JP) 2013-042170

(51) Int. Cl. H04N 5/225; H04N 7/18

(52) U.S. Cl. CPC H04N 5/2256; H04N 7/18
USPC 348/150

(57) ABSTRACT

A scanner apparatus comprises a casing having an image capturing window on the front surface thereof, an image capturing section, arranged inside the casing, configured to capture image of an object in a reading area invisibly formed outside the image capturing window of the casing, a plurality of lighting sections, arranged inside the casing, configured to irradiate light to the reading area, part of the light from the lighting sections being reflected on the inner surface of the image capturing window to become a stray light, and a shielding section configured to shield the stray light entering the image capturing section. The plurality of lighting sections mutually compensate the reduction in luminous intensity of the light from the lighting sections in the reading area caused by the shielding section.

### CROSS-REFERENCE TO RELATED APPLICATION

This application is based upon and claims the benefit of priority from Japanese Patent Application No. 2013-042170, filed on Mar. 4, 2013, the entire contents of which are incorporated herein by reference.

### FIELD

Embodiments described herein relate to a scanner apparatus.

### BACKGROUND

Conventionally, there is a scanner apparatus which extracts the feature amount of an object, such as a commodity, according to the image data obtained by capturing an image of the object through an image capturing element such as a CCD (Charge Coupled Device) sensor and compares the extracted feature amount with a pre-prepared feature amount for comparison to recognize the object. In such a scanner apparatus, it is generally performed that the reading area by an image capturing element is illuminated by a lighting device to secure the luminous intensity in the reading area. The use of the lighting device causes generation of a stray light due to the incidence of reflected illumination light to the image capturing element, and thus it is needed to arrange the lighting device at a proper location at which generation of the stray light is prevented. However, there is a possibility that an area at which a desired illumination can not be obtained is produced within the reading area if the lighting device is arranged at an improper location because unevenness in the luminous intensity by such lighting device occurs.

### BRIEF DESCRIPTION OF THE DRAWINGS

FIG. 1 is a side view illustrating a scanner apparatus together with a checkout counter according to an embodiment;

FIG. 2 is a longitudinal sectional view illustrating the scanner apparatus according to the embodiment;

FIG. 3 is a front view illustrating the internal structure of an image capturing window of the scanner apparatus according to the embodiment;

FIG. 4 is a diagram illustrating the stray light generated by a first lighting device;

FIG. 5 is a diagram illustrating the configuration of the first lighting device and a shielding section according to the embodiment;

FIG. 6 is a diagram illustrating an example of the distribution in luminance intensity of the illumination light of the first lighting device on the surface of the image capturing window;

FIG. 7 is a diagram illustrating the configuration of a second lighting device;

FIG. 8 is a diagram illustrating an example of the distribution in luminance intensity of the illumination light of the second lighting device on the surface of the image capturing window; and

FIG. 9 is a diagram illustrating an example of the distribution in luminance intensity of illumination lights of the first and second lighting devices on the surface of the image capturing window.

### DETAILED DESCRIPTION

In accordance with an embodiment, a scanner apparatus comprises a casing, an image capturing section, a plurality of lighting sections and a shielding section. The casing has an image capturing window arranged on the front surface thereof. The image capturing section is arranged inside the casing to capture an image of an object in a reading area invisibly formed outside the image capturing window. The plurality of lighting sections are arranged in the casing to irradiate light to the reading area, part of the light from the lighting sections being reflected on the inner surface of the image capturing window to become a stray light. The shielding section shields the stray light entering the image capturing section. Further, the plurality of lighting sections mutually compensate the reduction of luminous intensity of the light from the lighting sections in the reading area caused by the shielding section.

The scanner apparatus according to the present embodiment utilizes a general object recognition technology, which refers to a technology of recognizing the category of a target object, e.g. commodity, according to the image data obtained by photographing the target object with a camera. A computer extracts the appearance feature amount of the object contained in the image data. Then, the computer calculates a similarity degree by comparing the extracted appearance feature amount with the feature amount data of a reference image previously registered in a recognition dictionary file and recognizes the category of the object according to the similarity degree. The technology for recognizing an object contained in an image is described in the following document:

YANAI Keiji, ‘The current state and further directions on General Object Recognition’, in Proceedings of Information Processing Society of Japan, Vol. 48, No SIG 16, In URL:http://mm.cs.uec.ac.jp/IPSJ-TCVIM-Yanai.pdf [retrieved on Aug. 10, 2010].

In addition, the technology for carrying out a general object recognition through regional image segmentation for each object is described in the following document:

Jamie Shotton: ‘Semantic Texton Forests for Image Categorization and Segmentation, In URL:http://citeseerx.ist.psu.edu/viewdoc/download?doi=10.1. 1.145.3036&rep=repl&type=pdf [retrieved on Aug. 10, 2010].

An embodiment of the scanner apparatus according to the present invention is described in detail below with reference to the accompanying drawings. An arrow A shown in figures indicates a vertical direction of the scanner apparatus, an arrow B shown in figures indicates a length direction (back and forth direction) of the scanner apparatus, and an arrow C shown in figures indicates a width direction (left and -right direction) of the scanner apparatus.

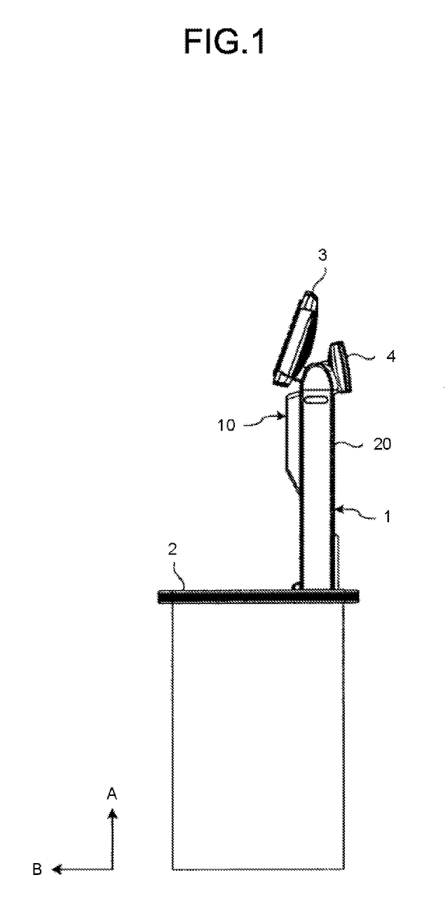

As shown in FIG. 1, the scanner apparatus 1 is a vertical type scanner apparatus. The scanner apparatus 1 with an image capturing window 11a is arranged on a checkout counter 2 in such a manner that the image capturing window 11a thereof is located at a position lower than the eyes of an operator who operates the scanner apparatus 1. The checkout counter 2 is a place on which a shopping basket is placed, and is arranged at a checkout area in a store. An operation input section 3 and a display 4 are arranged at the upper part of the scanner apparatus 1. The operation input section 3 having a touch panel display and a keyboard receives operation of an operator such as a shop clerk. The display 4 is, for example, a display for customer which displays the price of a commodity and the like.

The scanner apparatus 1 comprises a scanner main body 10 and a support section 20 which supports the scanner main body 10. The support section 20 is vertically arranged on the checkout counter 2. The scanner main body 10 is mounted on the upper part of the support section 20.

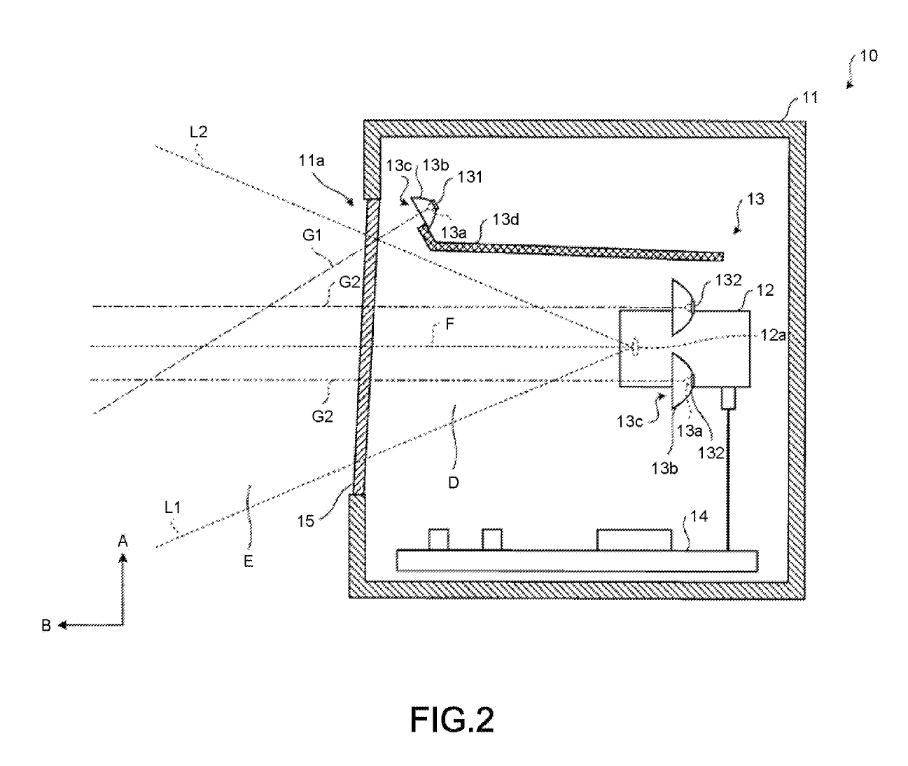

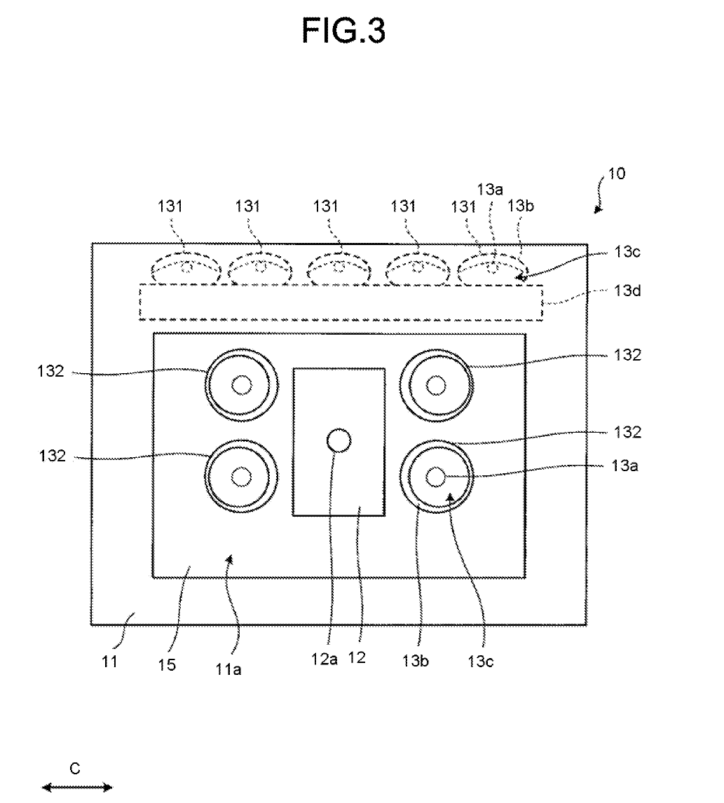

The constitution of the scanner apparatus 1 is described below. FIG. 2 is a longitudinal sectional view of the scanner apparatus. FIG. 3 is a front view illustrating the internal structure of the image capturing window 11a of the scanner apparatus 1.

The scanner main body 10 comprises a casing 11 having the image capturing window 11a at the front surface thereof, as described above. In the casing 11, the scanner main body 10 includes an image capturing device 12 having an image sensor 12a such as a CCD sensor or a CMOS sensor and the like, a lighting device 13 for irradiating an image capturing area D of the image capturing device 12 with illumination light therefrom, and an image processing board 14 for executing a processing relating to the recognition of a commodity according to the image data of the commodity acquired by the CCD sensor of the image capturing device 12. The image processing board 14 carries a circuit for carrying out an image processing, and the like. The image capturing area D of the image capturing device 12 is invisibly defined between dotted lines L1 and L2 shown in FIG. 2.

The casing 11, which is formed in a roughly rectangular parallelepiped box shape, has the image capturing window 11a on the front wall thereof. The casing 11 faces the operator who stands in front of the casing 11. The image capturing window 11a is substantially formed in a quadrangle in the front view.

The image capturing window 11a is closed with a transparent flat plate 15. The transparent flat plate 15, for example, made from glass or resin is supported at the casing 11. Specifically, the transparent flat plate 15 is supported at the casing 11 in such a manner that the flat plate 15 is fixed with an adhesive to the internal circumferential edge surfaces of the casing 11 at which the image capturing window 11a is formed. In this embodiment, the transparent flat plate 15 is inclined towards the front side of the casing 11 from the upper edge to the lower edge of the image capturing window 11a.

The image capturing device 12 is arranged at the substantially center portion of the image capturing window 11a, as shown in FIG. 3. The optical axis F of the image capturing device 12 is oriented to the center portion of the image capturing window 11a. The image capturing device 12 photographs the surrounding area of the image capturing window 11a from the inside of the casing 11 and outputs image data representing the image of the surrounding area. More specifically, the image capturing device 12 captures image of an object located in a reading area E invisibly formed outside the image capturing window 11a of the casing 11. The reading area E is an area which is equivalent to the area in which the operator holds the object in front of the image capturing window 11a within the image capturing area D.

The image capturing device 12 outputs image data of the object photographed. The image capturing device 12 receives light, reflected from the object located in the reading area E in front of (outside) the image capturing window 11a, which enters the casing 11 through the image capturing window 11a. The optical axis F of the image capturing device 12 (image photographing lens) extends along the back and forth direction of the scanner apparatus 1 and passes through the image capturing window 11a.

The image photographing range of the CCD image capturing element of the image capturing device 12 depends on properties of the image photographing lens. In this embodiment, the image photographing lens is a fixed focus lens, the focal point (the position at which image is in focus) of which is apart from the front edge of the lens by a given distance. Image of a commodity (target object) having a highest resolution can be obtained if the commodity is located at the focal point. The image of the commodity becomes out-of-focus and the resolution of the commodity decreases if the commodity is moved closer to or away from the CCD image capturing element with reference to the focal point.

The lighting device 13 includes a plurality of first lighting devices 131 arranged nearby the upper edge of the image capturing window 11a and a plurality of second lighting devices 132 arranged around the image capturing device 12. The numbers of the first and second lighting devices 131 and 132 are not limited to the example shown in FIG. 2 and FIG. 3.

The lighting device 13 (the first lighting devices 131 and the second lighting devices 132) includes a light source section 13a and a reflector 13b for condensing and radiating the light from the light source section 13a. The light source section 13a comprises one or more LEDs (Light Emitting Diode) serving as a light source. The reflector 13b, which has, for example, a cone-shaped mirror surface at the inner side thereof, has a substantially circular opening 13c at the front side thereof.

Further, the lighting device 13 (the first and second lighting devices 31 and 132) is located outside the reading area E within the casing 11.

The first lighting devices 131 corresponding to a first lighting section are arranged along the upper edge of the image capturing window 11a to radiate lights from the location (upper edge) above the optical axis F of the image capturing device 12 to the reading area E in front of the image capturing window 11a. More specifically, the first lighting devices 131 are horizontally arranged at intervals outside the reading area E along the upper edge of the image capturing window 11a. The respective optical axis G1 of the first lighting devices 131 is oriented to the reading area E from the location above the image capturing area D behind the image capturing window 11a. In this way, the first lighting devices 131 respectively illuminate the reading area E from the above-described location, thereby preventing the illumination lights of the first lighting devices 131 from entering the eyes of the operator standing opposite to the image capturing window 11a.

Further, a shielding section 13d is arranged below the first lighting devices 131 to shield a part of each opening 13c of the first lighting devices 131. The shielding section 13d shields stray light caused with the reflection of the illumination lights of the first lighting devices 131 by the image capturing window 11a. The stray light generated by the illumination lights of the first lighting devices 131 is described below. To simplify the description below, one of the first lighting devices 131 is referred.

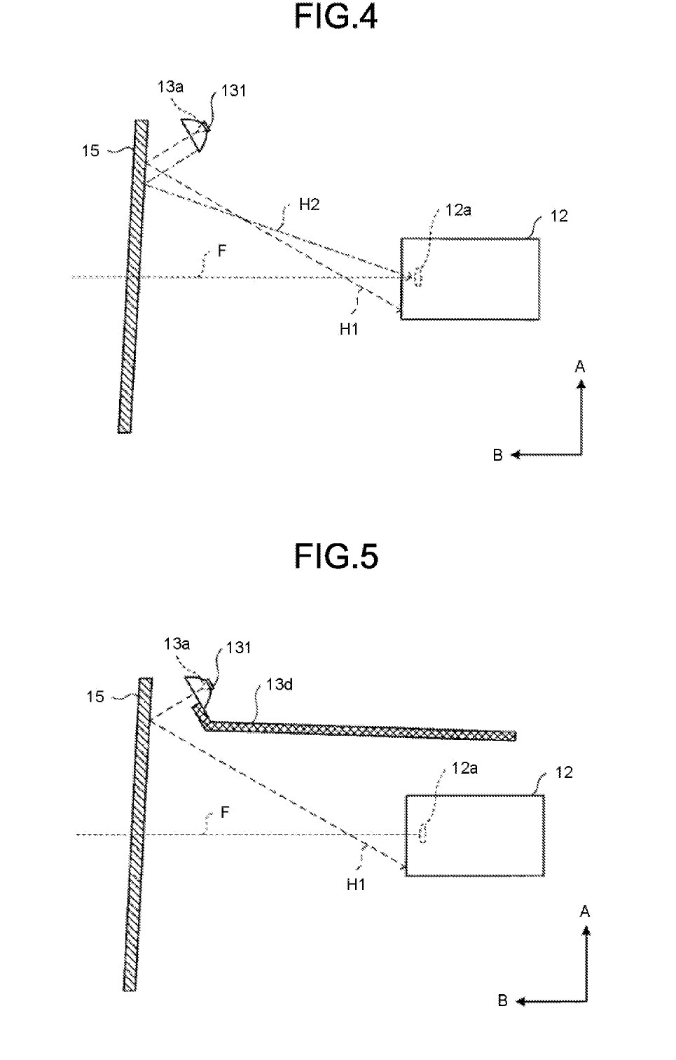

FIG. 4 is a diagram illustrating the stray light generated by the illumination light of the first lighting device 131. As shown in FIG. 4, the first lighting device 131 radiates illumination light to the reading area E in front of the image capturing window 11a from the location above the image capturing area D. At this time, illumination light is partially reflected on the inner surface of the transparent plate 15, and the reflected lights (refer to H1 and H2) reach the image capturing device 12 inside the casing 11. The reflected light H1 of the reflected lights H1 and H2, reaching the image capturing device 12, which does not enter the image sensor 12a does not become stray light while the reflected light H2 entering the image sensor 12a becomes stray light.

Thus, according to the scanner main body 10 of the present embodiment, in the opening 13c of the first lighting device 131, the shielding section 13d shields the illuminated part (the lower part of the first lighting device 131) of the first lighting device 131 which causes the reflected light H2, as shown in FIG. 5. In this way, the stray light generated by the illumination light from the first lighting device 131 is eliminated. The shielding section 13d may be part of the first lighting device 131, an extended part of the casing 11 or an independent component.

Further, since a part of the illumination light radiated from the light source section 13a of the first lighting device 131 is shielded by the shielding section 13d, the luminous intensity of the illumination light corresponding to the shielded part thereof reduces in the reading area E.

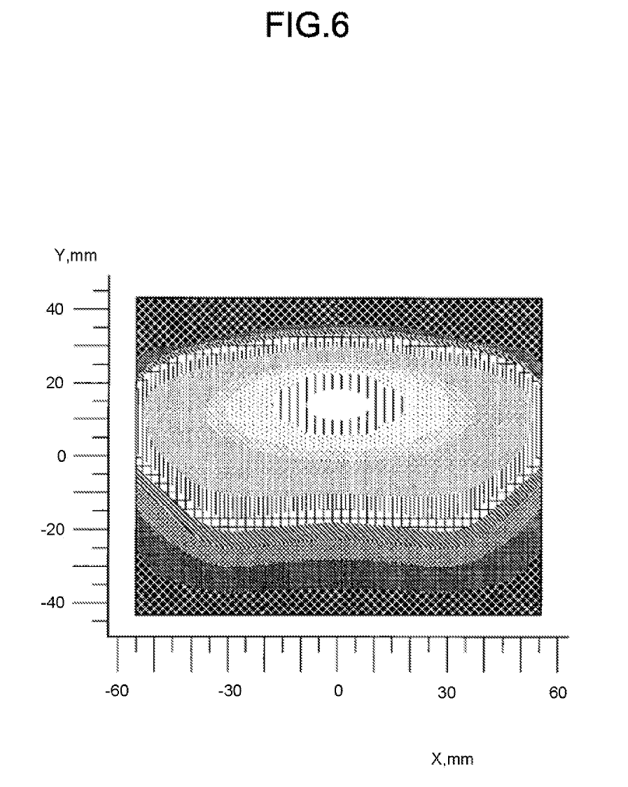

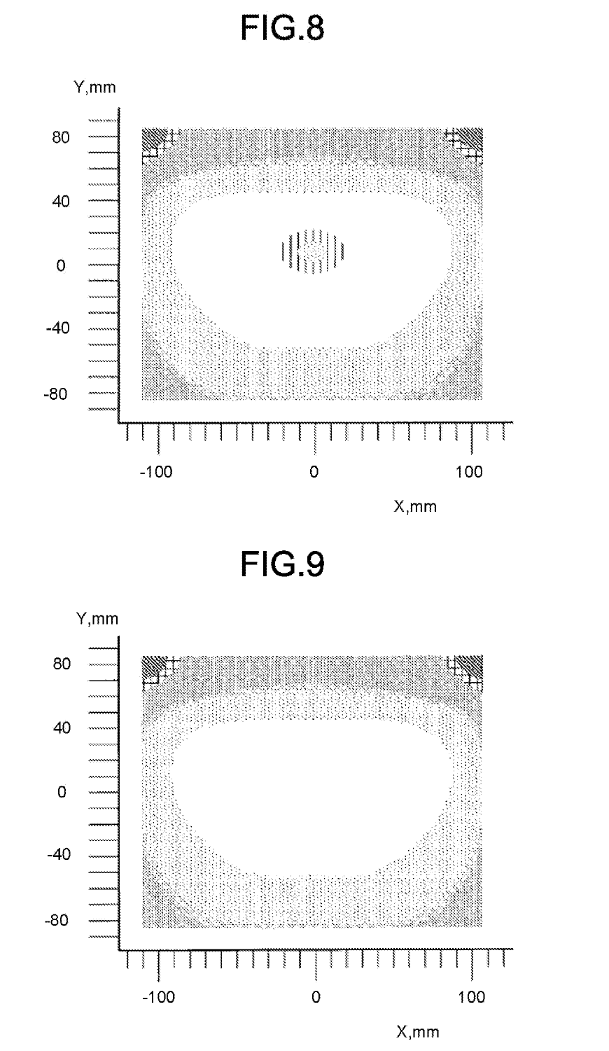

FIG. 6 is a diagram illustrating an example of the distribution in the luminous intensity of the illumination light of the first lighting device 131 on the surface of the image capturing window 11a, i.e., the surface of the transparent plate 15. In FIG. 6, the vertical axis indicates the vertical direction (height direction) of the image capturing window 11a, and the horizontal axis indicates the horizontal direction (width direction) of the image capturing window 11a. (X, Y)=(0, 0) means the center position of the image capturing window 11a. Further, in FIG. 6, the density of the hatching represents the magnitude of luminous intensity, and the thinner the hatching is, the higher the luminous intensity is. In FIG. 8 and FIG. 9, the horizontal axes, the vertical axes and the illuminance are defined in the same way as in FIG. 6.

As shown in FIG. 6, luminous intensity of the illumination light irradiated by the first lighting device 131 in the vicinity of the center of the image capturing window 11a reaches its peak level and gets lower and lower toward the outer edges of the image capturing window 11a. Further, due to the relatively short separation distance between the first lighting device 131 and the image capturing window 11a and the irradiation from the location above the image capturing window 11a, there is a tendency that the upper part of the image capturing window 11a is higher in luminous intensity than the lower part of the image capturing window 11a. Furthermore, the reduction in the light quantity caused by the shielding of the shielding section 13d makes luminous intensity at the lower part of the image capturing window 11a further reduce compared with the upper part of the image capturing window 11a. Thus, unevenness in luminous intensity of the illumination light reaching the reading area E occurs if only the first illuminator 131 is used to illuminate, and then there is a possibility that an area at which a sufficient luminous intensity required to recognize (photograph) an object can not be secured exists.

Returning to FIG. 2 and FIG. 3, the second lighting devices 132 corresponding to the second lighting section are arranged around the image capturing device 12. The optical axis G2 of each second lighting device 132 is substantially the same as the optical axis F of the image capturing device 12 (image sensor 12a). More specifically, the second lighting devices 132 are arranged at a plurality of positions where a reference axis orthogonal to the optical axis F of the image capturing device 12 is taken as the center of an axial or line symmetry. It is shown as an example in this embodiment that the second lighting devices 132 are respectively arranged at four positions located at regular intervals where a vertical reference axis orthogonal to the optical axis F of the image capturing device 12 is taken as a center of an axial symmetry. The second lighting devices 132 radiate light to the reading area E from a position behind the image capturing area D which is formed behind the image capturing window 11a.

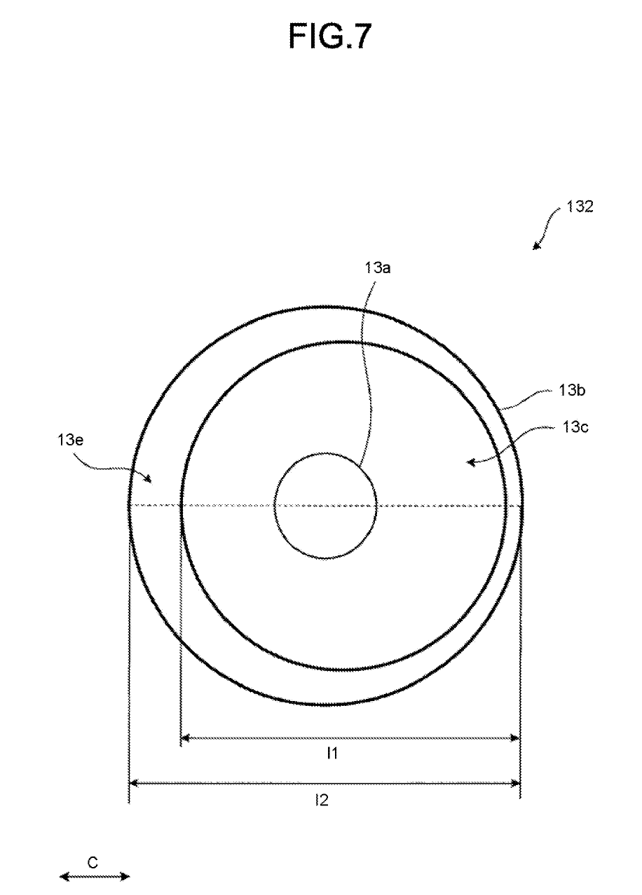

As shown in FIG. 7, the diameter I1 of the opening 13c of the second lighting device 132 is formed to be smaller than the maximum diameter I2 of the reflector 13b. The center of the opening 13c of the second lighting device 132 is eccentrically positioned by a given amount in a direction away from the image capturing device 12. The shielding section 13e of the reflector 13b generated by the eccentricity shields part of the illumination light irradiated from the second lighting device 132. More specifically, the shielding section 13e shields the light which is reflected to the internal side of the image capturing window 11a and enters the image capturing device 12 (image sensor 12a) within the illumination light from the second lighting device 132. In this way, the stray light generated by the illumination light of the second lighting device 132 is eliminated.

As described above, part of the illumination light irradiated from the light source section 13a of the second lighting device 132 is shielded by the shielding section 13e, and thus, the luminous intensity of the illumination light corresponding to the shielded part is reduced in the reading area E.

FIG. 8 is a diagram illustrating an example of the distribution in luminous intensity of the illumination light of the second lighting devices 132 on the surface of the image capturing window 11a. Compared with the first lighting device 131, the second lighting device 132 has a longer separation distance to the image capturing window 11a, and the optical axis G2 thereof is substantially parallel to the optical axis F of the image capturing device 12. Therefore, a substantially uniform distribution in luminous intensity in the direction of the optical axis F can be realized on the surface of the image capturing window 11a, i.e., in the reading area E. However, due to the reduction in the light quantity caused by shielding the illumination light by the shielding section 13e, as described above, the luminous intensity at substantially central area of the image capturing window 11a is lower than other areas thereof. Thus, unevenness in luminous intensity of the illumination light reaching the reading area E occurs if only the second lighting devices 132 are used. And there is a possibility that an area in which a sufficient luminous intensity required to recognize (photograph) the object cannot be achieved is formed.

However, there is a complementary relationship between the first and the second lighting devices 131 and 132 in the compensation for the reduction of the luminous intensity in the reading area E caused by the elimination of stray light, as shown in FIG. 6 and FIG. 8. The complementary relationship refers to the mutual compensation with illumination by the first and second lighting devices 131 and 132 on the insufficient luminous intensity at the reading area E caused by shielding a part of the illumination light from the first lighting devices 131 by the shielding section 13d and a part of the illumination light from the second lighting devices 132 by the shielding section 13e. The reduction in the luminous intensity of the first lighting devices 131 due to the shielding of the shielding section 13d is compensated by the second lighting devices 132, and the reduction in the luminous intensity of the second lighting devices 132 due to the shielding of the shielding section 13e is compensated by the first lighting devices 131. Thus, in the scanner apparatus 1 according to the present embodiment, distribution in luminous intensity (refer to FIG. 9) combined with the distributions in luminous intensity shown in FIG. 6 and FIG. 8 is formed on the surface of the image capturing window 11a (the reading area E) through the first and second lighting devices 131 and 132 which are used simultaneously.

FIG. 9 is a diagram illustrating an example of the distribution in luminance intensity of illumination lights from the first lighting devices 131 and the second lighting devices 132 on the surface of the image capturing window 11a. As shown in FIG. 9, the luminous intensity reduced in a case in which the first lighting devices 131 or the second lighting devices 132 is separately used is compensated by the second lighting devices 132 or the first lighting devices 131 through the first and second lighting devices 131 and 132 which are used, simultaneously. In this way, stray light can be eliminated while a sufficient luminance intensity in the reading area E can be secured, thereby providing a suitable environment for the image capturing(recognition) of an object.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

For example, in the embodiment described above, the present invention is applied to a scanner apparatus which uses an object recognition technology of recognizing an object according to the image data obtained by photographing the object. However, the present invention is not limited to this case, and it may also be applied to a scanner apparatus for reading a code symbol such as a barcode or a two-dimensional code and the like.

Further, in the embodiment described above, an LED is used as a light source, however, the present invention is not limited to this case, and other light sources are also applicable.

Still further, in the embodiment described above, the image capturing window formed in a rectangle or quadrangle shape is described as an example thereof. However, the present invention is not limited to this case, and the image capturing window may also be formed, for example, in a pentagon shape or hexagon shape and the like.

Further, in the embodiment described above, two lighting devices, i.e., first lighting devices 131 and second lighting devices 132 are used. However, the present invention is not limited to this case, and three or more lighting devices may be used as well. Additionally, in this case, the lighting devices are formed such that luminous intensity of one of the lighting devices reduced in the reading area E due to the shielding by the shielding section is mutually compensated by other lighting devices.

What is claimed is:

1. A scanner apparatus, comprising:
a casing having an image capturing window on the front surface thereof;
an image capturing section, arranged inside the casing, configured to capture image of an object in a reading area invisibly formed outside the image capturing window of the casing;
a plurality of lighting sections, arranged inside the casing, configured to irradiate light to the reading area, part of the light from the lighting devices being reflected on the inner surface of the image capturing window to become a stray light; and
a shielding section configured to shield the stray light entering the image capturing section, wherein
the lighting sections mutually compensate the reduction in luminous intensity of the light in the reading area caused by the shielding section.

2. The scanner apparatus according to claim 1, wherein the plurality of lighting sections include a first lighting section illuminating the reading area from a position above the image capturing section and a second lighting section illuminating the reading area from the optical axis direction of the image capturing section.

3. The scanner apparatus according to claim 2, wherein the first lighting section having a specific opening is arranged along the upper edge of the image capturing window, and the opening of the first lighting section is partially shielded by the shielding section.

4. The scanner apparatus according to claim 3, wherein the shielding section shielding the light from the first lighting section is formed with a part of the casing.

5. The scanner apparatus according to claim 2, wherein the second lighting section having a specific opening is arranged around the image capturing section, and the opening of the second lighting section is partially shielded by the shielding section.

6. The scanner apparatus according to claim 2, wherein the second lighting section includes a plurality of lighting devices, and the lighting devices are respectively arranged at a plurality of positions where a reference axis orthogonal to the optical axis of the image capturing section is taken as a center of an axial symmetry.

7. The scanner apparatus according to claim 1, wherein the object in the reading area is recognized according to the image captured by the image capturing section.
